(19) United States
(12) Patent Application Publication
(10) Pub. No.: US 2025/0283651 A1
(43) Pub. Date: Sep. 11, 2025

(54) COMPRESSOR CHASSIS AND COOLING APPLIANCE HAVING THE SAME

(71) Applicant: SAMSUNG ELECTRONICS CO., LTD., Suwon-si (KR)

(72) Inventors: Hunchul JUNG, Suwon-si (KR); Mincheol KIM, Suwon-si (KR); Namgyu GWON, Suwon-si (KR); Dohyeon PARK, Suwon-si (KR)

(21) Appl. No.: 19/217,034

(22) Filed: May 23, 2025

Related U.S. Application Data
(63) Continuation of application No. PCT/KR2023/015683, filed on Oct. 12, 2023.

(30) Foreign Application Priority Data
Dec. 1, 2022 (KR) 10-2022-0165870

(51) Int. Cl. F25D 19/00; B23P 15/00

(52) U.S. Cl. CPC F25D 19/00; B23P 15/00

(57) ABSTRACT

A cooling appliance includes a main body in which a compressor chamber is defined, a chassis which is in the compressor chamber, the chassis defining a fastening portion to which a fastening member is screw-coupled to the chassis, and a support portion which is extended from the fastening portion and connects the fastening portion to a portion of the chassis which is adjacent to the support portion, and a compressor of a cool air generator which is in the compressor chamber, penetrated by the fastening member and detachably attached to the chassis by the fastening member.

### CROSS-REFERENCE TO RELATED APPLICATION

This application is a continuation application of International Application No. PCT/KR2023/015683 designating the United States, filed on Oct. 12, 2023, in the Korean Intellectual Property Receiving Office and claiming priority to Korean Patent Application No. 10-2022-0165870 filed on Dec. 1, 2022 in the Korean Intellectual Property Office, the disclosure of which is incorporated by reference herein in its entirety.

### BACKGROUND

### (1) Field

The disclosure relates to a refrigerator as a cooling appliance having a compressor attachment portion to which a compressor is bolt-fastened.

### (2) Description of the Related Art

In general, a refrigerator is a home appliance including a storage chamber for storing food, and a cold air generation unit for supplying cold air to the storage chamber through a refrigeration cycle to keep the food fresh.

The cold air generation unit drives the refrigeration cycle to supply cold air to the storage chamber. The cold air generation unit includes a compressor which compresses a gaseous refrigerant to a high-temperature and high-pressure state, a condenser which condenses the compressed refrigerant into a liquid phase, an expansion device which expands the condensed refrigerant, and an evaporator which evaporates the liquid-state refrigerant to generate cold air.

### SUMMARY

As a result of condensing the gaseous refrigerant which is compressed into the high-temperature and high-pressure state, into a liquid state, the condenser radiates heat to the outside. The heat radiation of the condenser raises the temperature of air around the condenser. Therefore, the cold air generation unit further includes a blower fan to exhaust the high-temperature air around the condenser to the outside and to continuously draw outside air into the condenser.

The disclosure provides a compressor attachment portion enabling a compressor to be bolt-fastened directly to a chassis without a separate connection member.

According to an embodiment of the disclosure, there is provided a refrigerator including a main body, a machinery chamber provided in a lower portion of the main body, a compressor disposed in the machinery chamber, a chassis supporting the compressor, and a compressor attachment portion provided in the chassis and allowing the compressor to be detachably attached thereto, in which the compressor attachment portion includes a support portion integrally formed with the chassis, and a fastening portion extending from the support portion in a burring shape and screw-coupled to a bolt penetrating a partial portion of the compressor.

The support portion may have the same thickness as the chassis.

The thickness of the support portion may be about 0.8 millimeter (mm) to about 1.0 mm. The fastening portion has a larger thickness than the support portion. The thickness of the fastening portion may be about 1.15 millimeters (mm) to about 1.25 mm.

The thickness of the support portion may be about 1.2 mm to about 1.4 mm. The fastening portion may have a smaller thickness than the support portion. The thickness of the fastening portion may be about 1.1 mm to about 1.3 mm.

The fastening portion may have a height of 4.0 about mm to 4.5 about mm from an upper surface of the support portion.

According to another embodiment of the disclosure, there is provided a molding method for a compressor attachment portion to which a compressor provided in a refrigerator is attached. The molding method includes a drawing process for forming a molded portion by deforming a portion of a chassis connected to the compressor to be convex using a first drawing punch, a re-drawing process for increasing a height of the molded portion and decreasing a diameter of the molded portion using a second drawing punch having a smaller diameter than the first drawing punch, a piercing process for forming a through hole in an upper end of the molded portion by perforating the molded portion using a piercing punch, a first forging process for forming a fastening portion deformed to have a burring shape from the molded portion by penetrating the molded portion using a burring punch, and striking an upper end of the fastening portion using a first forging punch to thicken the fastening portion to have a first thickness, and a second forging process for striking the upper end of the fastening portion using a second forging punch to thicken the fastening portion to have a second thickness larger than the first thickness and larger than a thickness of a support portion extending to a lower end of the fastening portion.

The re-drawing process may include a first re-drawing process for deforming the fastening portion to have a first height and a first diameter, and a second re-drawing process for deforming the fastening portion to have a second height larger than the first height and a second diameter smaller than the first diameter.

The molding method may further include a tapping process for forming a screw thread on an inner circumferential surface of the fastening portion using a cutting tool.

According to another embodiment of the disclosure, there is provided a molding method for a compressor attachment portion to which a compressor provided in a refrigerator is attached. The molding method includes a drawing process for forming a molded portion by deforming a portion of a chassis connected to the compressor to be convex using a first drawing punch, a piercing process for forming a through hole in an upper end of the molded portion by perforating the molded portion using a piercing punch, a re-drawing process for increasing a height of the molded portion and decreasing a diameter of the molded portion using a second drawing punch having a smaller diameter than the first drawing punch, a molding process for decreasing the diameter of the molded portion using a molding punch having a smaller diameter than the second drawing punch, and a burring process for forming a fastening portion by penetrating the molded portion using a burring punch to deform the molded portion to have a burring shape, in which the fastening portion is formed to have a thickness smaller than a thickness of a support portion extending to a lower end of the fastening portion.

The re-drawing process may include a plurality of re-drawing processes for deforming the fastening portion to gradually increase a height of the fastening portion and gradually decrease a diameter of the fastening portion.

The molding method may further include a tapping process for forming a screw thread on an inner circumferential surface of the fastening portion using a cutting tool.

### BRIEF DESCRIPTION OF THE DRAWINGS

The above and/or other aspects of the disclosure will be more apparent by describing embodiments of the disclosure with reference to the accompanying drawings, in which:

FIG. 1 is a perspective view illustrating a front side of a refrigerator according to an embodiment of the disclosure.

FIG. 2 is an exploded perspective view illustrating a rear side of the refrigerator according to an embodiment of the disclosure.

FIG. 3 is an exploded perspective view illustrating a compressor attachment portion provided in the refrigerator according to an embodiment of the disclosure.

FIG. 4 is a perspective view illustrating a chassis in which the compressor attachment portion provided in the refrigerator is provided according to an embodiment of the disclosure.

FIG. 5 is a cross-sectional view taken along line A-A illustrated in FIG. 4.

FIG. 6 is a flow chart illustrating a method of providing the compressor attachment portion according to an embodiment of the disclosure.

FIGS. 7A to 7G are cross-sectional diagrams illustrating the method of providing the compressor attachment portion according to an embodiment of the disclosure.

FIG. 8 is a flow chart illustrating a method of providing the compressor attachment portion according to an embodiment of the disclosure.

FIGS. 9A to 9H are cross-sectional diagrams illustrating the method of providing the compressor attachment portion according to an embodiment of the disclosure.

### DETAILED DESCRIPTION

It should be understood that embodiments to be described below are exemplarily provided to help the understanding of the disclosure, and the disclosure may be modified in various ways, unlike the embodiments described herein. However, in the following description of the disclosure, if it is determined that a detail description of a related known function or component may unnecessarily obscure the gist of the disclosure, the detailed description and concrete illustration thereof will be omitted. Further, the accompanying drawings are not necessarily illustrated to actual scale but dimensions of some components may be exaggerated to help the understanding of the disclosure.

It will be understood that when an element is referred to as being related to another element such as being “on” another element, it can be directly on the other element or intervening elements may be present therebetween. In contrast, when an element is referred to as being related to another element such as being “directly on” another element, there are no intervening elements present.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

The terms “first,” “second” and the like may be used to describe various components, but the components should not be limited by these terms. These terms are used only for the purpose of distinguishing one component from another component. For example, a first component may be referred to as a second component, and similarly, the second component may also be referred to as the first component without departing from the scope of the disclosure.

Unless otherwise defined, the terms used in the embodiments of the disclosure may be interpreted as having meanings commonly known to those having ordinary skill in the art.

The terms such as “front end,” “rear end,” “upper portion,” “lower portion,” “upper end,” and “lower end” used in the disclosure are defined based on the drawings, and the shape and position of each component are not limited by the terms.

The expression “same” used in the disclosure may not only mean a complete match, but also include a difference to such an extent that a processing error range is considered.

Meanwhile, various elements and areas in the drawings are illustrated schematically. Accordingly, the technical idea of the disclosure is not limited by the relative sizes or intervals illustrated in the accompanying drawings. In describing the disclosure, if it is determined that a detail description of a related known function or component may unnecessarily obscure the gist of the disclosure, the detailed description thereof will be simplified or omitted.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Hereinafter, a refrigerator 1 as a cooling appliance according to an embodiment of the disclosure will be described in detail with reference to the accompanying drawings so that it can be easily implemented by those having ordinary skill in the art to which the disclosure pertains.

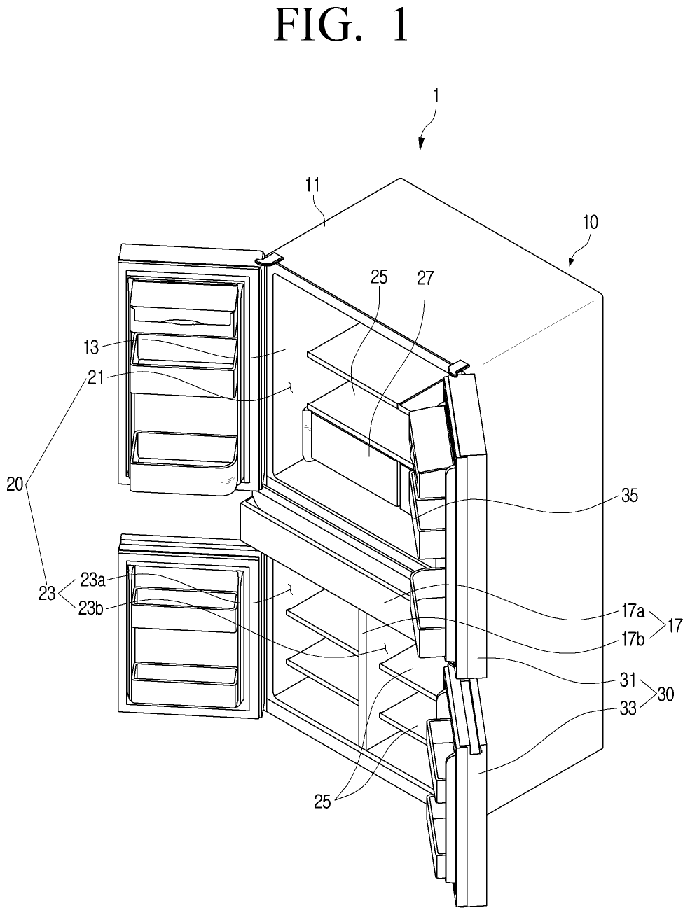

FIG. 1 is a perspective view illustrating a front side of a refrigerator 1 according to an embodiment of the disclosure. FIG. 1 shows the cooling appliance being open at the front side.

Referring to FIG. 1, a refrigerator 1 includes a main body 10, a storage compartment 20, and a door 30.

The main body 10 includes an outer case 11 and an inner case 13. The outer case 11 forms an exterior appearance of the main body 10. The outer case 11 may be made of or include a metal material having excellent durability and aesthetics. The inner case 13 is positioned inside the outer case 11. The inner case 13 forms an exterior appearance of the storage compartment 20. The inner case 13 may be integrally injection-molded with a plastic material. An insulating material may be foamed (or provided) between the inner case 13 and the outer case 11 to prevent cold air from flowing out of the storage compartment 20.

The storage compartment 20 is exposed to outside the main body 10 being open at the front side of the cooling appliance so that food can be taken in and out. Here, the main body 10 may define an opening through which the storage compartment 20 is accessible from the front side of the cooling appliance. According to an embodiment, the storage compartment 20 may be divided into a plurality of storage compartments (or sub-compartments) by a partition wall 17. The partition wall 17 may be disposed within the inner case 13. The storage compartment 20 divided into a plurality of storage compartments by the partition wall 17 may include an upper storage compartment 21 and a lower storage compartment 23. Here, the main body 10 may define openings through which the sub-compartments are respectively accessible from outside the cooling appliance, through the open front side thereof The upper storage compartment 21 and the lower storage compartment 23 may be separated by a first partition wall 17a. The lower storage compartment 23 may be divided into a left storage compartment 23a and a right storage compartment 23b by a second partition wall 17b.

The storage compartment 20 may include a refrigerating compartment and a freezing compartment. Depending on the type of refrigerator 1, the upper storage compartment 21 may be provided as a refrigerating compartment and the lower storage compartment 23 may be provided as a freezing compartment. Alternatively, the upper storage compartment 21 may be provided as a freezing compartment and the lower storage compartment 23 may be provided as a refrigerating compartment. The freezing compartment and the refrigerating compartment may be thermally insulated by the first partition wall 17a. The freezing compartment may be maintained at about −20 degrees Celsius (° C.), and the refrigerating compartment may be maintained at about 3° C. However, the temperature of the freezing compartment and refrigerating compartment may be changed according to various conditions such as the external temperature and the installation location of the cooling appliance.

A shelf 25 and a storage container 27 may be installed inside the storage compartment 20. The shelf 25 is provided to support food stored in the storage compartment 20. A plurality of shelves 25 may be provided in each storage compartment 20. The shelf 25 may be provided to be detachable from and attachable to the storage compartment 20. The storage container 27 may be provided in a box shape. The storage container 27 may be provided to store food in a sealed inner space. The storage container 27 may be detachable from and attachable to the storage compartment 20.

The storage compartment 20 is opened and closed by a position of the door 30 relative to the main body 10. The door 30 is pivotably connected to the main body 10 to open and close the open front side of the storage compartment 20. The upper storage compartment 21 and the lower storage compartment 23 are opened and closed by an upper door 31 and a lower door 33, respectively, which are each pivotably connected to the main body 10. Each of the upper door 31 and the lower door 33 may be provided in a double-door type. Here, each of the upper door 31 and the lower door 33 may be two sub-doors respectively connected to opposing sides of the main body 10 and respectively functioning to open and close a portion of the storage compartment 20. A plurality of door guards 35 in which food and the like may be stored, may be provided on the back (e.g., inner) sides of the upper door 31 and the lower door 33. These door guards 35 may also be detachable from and attachable to respective sub-doors.

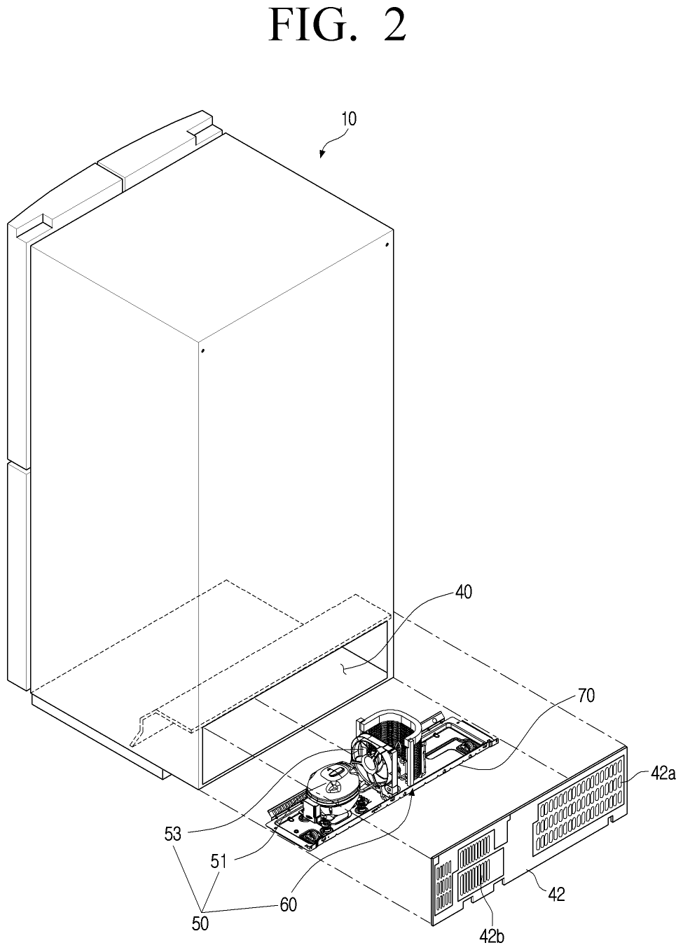

FIG. 2 is an exploded perspective view illustrating a machinery chamber and a cold air generation unit from the rear side of the refrigerator 1 according to an embodiment of the disclosure.

The machinery chamber 40 may be a volume or space within the main body 10 which is accessible from the rear side of the cooling appliance, such as through a chamber opening defined in the main body 10. The machinery chamber 40 may include a rear cover 42 which separates the volume of the machinery chamber 40 from outside the cooling appliance when installed to the main body 10. The rear cover 42 may be provided to open and close the machinery chamber 40 at the rear side of the main body 10 which is opposite to the front side of the cooling appliance along a first direction, e.g., a front-back direction.

The rear cover 42 may have an inlet port 42a through which air is brought into the machinery chamber 40 from outside the main body 10, and an outlet port 42b through which air inside the machinery chamber 40 is discharged to the outside (e.g., the outside of the main body 10). The inlet port 42a may be provided in plural including a plurality of inlet ports 42a and the outlet port 42b may be provided in plural including a plurality of outlet ports 42b. The inlet port 42a and the outlet port 42b may be provided at different positions along the rear cover 42. In an embodiment, the various air ports may be defined in a body of the rear cover 42, such as being enclosed openings extended completely through a thickness of the cover body to allow airflow between the machinery chamber 40 and the outside. The group of air inlet ports and the group of air outlet ports are shown in FIG. 2 to be adjacent to each other along a second direction, e.g., a left-right direction.

The refrigerator 1 according to an embodiment of the disclosure may further include a cold air generation unit 50 which generates and supplies cold air to the storage compartment 20. The cold air generation unit 50 may include a compressor 51, a condenser 60, an expansion valve (not shown), and an evaporator (not shown). The cold air generation unit 50 may operate a refrigeration cycle of the cooling appliance by using the compressor 51, the condenser 60, the expansion valve and the evaporator, thereby generating cold air.

The compressor 51 compresses a refrigerant to a high-temperature and high-pressure state. The compressor 51 may be supplied with electric energy from the outside to compress a gaseous refrigerant to a high-temperature and high-pressure state using a rotational force of an electric motor or the like. The compressor 51 may be connected (e.g., fluidly, electrically, etc.) to the condenser 60 and operate to move the compressed refrigerant to the condenser 60. The compressor 51 may be positioned inside the machinery chamber 40 (e.g., a compressor chamber). The compressor 51 compresses the refrigerant and pushes the compressed refrigerant into the condenser 60 to operate a refrigeration cycle including processes of compression, condensation, expansion, and evaporation. Therefore, when the compressor 51 is in operation, cold air generated in the evaporator is supplied to the storage compartment 20.

The condenser 60 condenses the high-temperature and high-pressure refrigerant which is compressed by the compressor 51. The condenser 60 dissipates heat generated while condensing the refrigerant. The refrigerant which is condensed while passing through the condenser 60 moves to the expansion valve. That is, the condenser 60 and the expansion valve may be connected to each other. The refrigerant which is condensed by the condenser 60 becomes a low-temperature and low-pressure liquid state while passing through the expansion valve. The liquid-state refrigerant passes through the expansion valve and moves to the evaporator. That is, the expansion valve and the evaporator may be connected to each other.

The evaporator evaporates the low-temperature and low-pressure liquid refrigerant which has passed through the expansion valve. While the liquid refrigerant is evaporated by the evaporator, the refrigerant exchanges heat with surrounding gas. While the liquid refrigerant is evaporated, the refrigerant absorbs latent heat from the surroundings, thereby cooling the gas surrounding the evaporator and generating cold air. The completely evaporated refrigerant is supplied back to the compressor 51, so that the cooling cycle continues.

Some components of the cold air generation unit 50 as a cool air generator may be positioned inside the machinery chamber 40. According to an embodiment of the disclosure, the compressor 51, the condenser 60, and a blower fan 53 may be positioned inside the machinery chamber 40.

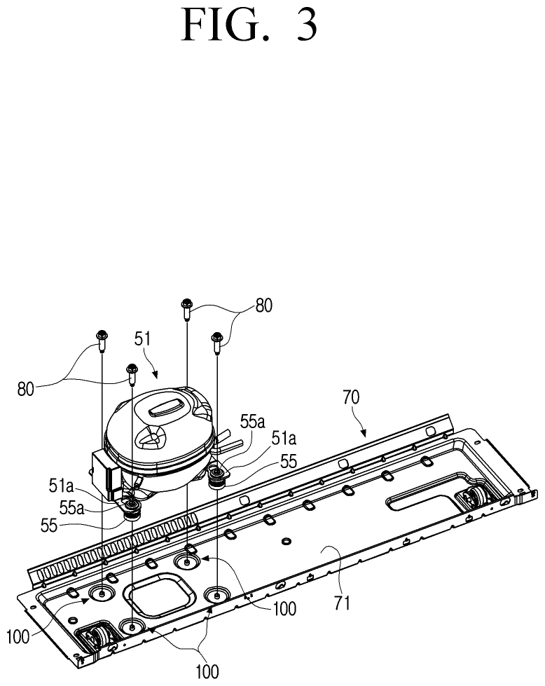

FIG. 3 is an exploded perspective view illustrating a compressor attachment portion 100 of the refrigerator 1 according to an embodiment of the disclosure.

Referring to FIG. 3, the compressor 51 may be fixed to a chassis 70 disposed at the bottom of the machinery chamber 40, via a plurality of bolts 80. The compressor 51 may have a support piece 51a formed (or provided) at each of the front side and the rear side of the lower portion thereof. The support piece 51a may be formed to protrude from both sides of the compressor 51, such as protruding further from a body of the compressor 51 to allow attachment of the body to the chassis 70.

A damper 55 may be coupled to each of both ends of a support piece 51a. The damper 55 may have a through hole 55a defined therein and formed along a length direction. The bolt 80 may be inserted into the through hole 55a of the damper 55. A leading end portion of the bolt 80 inserted into the through hole 55a of the damper 55 may be screwed to a fastening portion 115 of a compressor attachment portion 100 of the chassis 70. Here, the fastening portion 115 may correspond to a location of the through hole 55a, to allow attachment of the compressor 51 to the chassis 70.

The damper 55 may be made of an elastic material to absorb vibrations. The damper 55 may be disposed between the support piece 51a of the compressor 51 and the chassis 70 along a third direction (e.g., a top-down direction or thickness direction). Two dampers 55 may be respectively disposed on both sides of the front of the compressor 51, and two dampers 55 may be respectively disposed on both sides of the rear of the compressor 51. The plurality of dampers 55 can absorb vibrations generated when the compressor 51 is driven and reduce noise caused by the vibrations.

The compressor attachment portion 100 according to an embodiment of the disclosure may be provided in the chassis 70. Here, a body of the chassis 70 may define the compressor attachment portion 100. The compressor attachment portion 100 may be provided in a number corresponding to the attachment points at which the compressor 51 and the chassis 70 are connected to each other by the bolts 80. For example, as shown in FIG. 3, four compressor attachment portions 100 may be provided in the chassis 70 to correspond to four bolts 80 used for a four-point connection of the compressor 51 to the chassis 70.

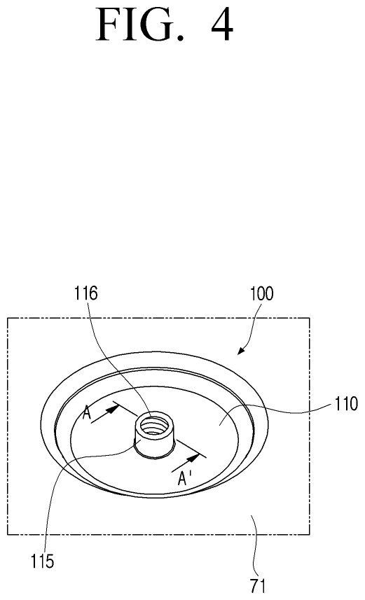

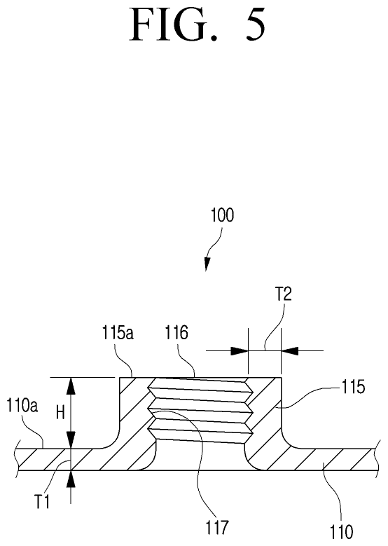

FIG. 4 is a plan view illustrating a chassis 70 in which the compressor attachment portion 100 is provided according to an embodiment of the disclosure. FIG. 5 is a cross-sectional view taken along line A-A illustrated in FIG. 4.

Referring to FIG. 4, the compressor attachment portion 100 may be provided in or defined by portions of the chassis 70. For example, the compressor attachment portion 100 may be integrally formed with a remainder of the chassis 70 through a sheet forging and thickening method. The compressor attachment portion 100 may include a support portion 110 and a fastening portion 115 which protrudes from the support portion 110.

The chassis 70 may have a plate portion along which the compressor attachment portion 100 is defined. The plate portion may have an upper surface 71 facing the storage compartment 20. The upper surface 71 may be disposed in a plane defined by the first and second directions crossing each other.

An upper surface 110a (see FIG. 5) of the support portion 110 may be disposed at a height lower than an upper surface 71 of the chassis 70. That is, the compressor attachment portion 100 may be recessed from the plate portion of the chassis 70. In this case, the compressor attachment portion 100 may have a groove shape, and the support portion 110 may form a bottom of the groove shape. In a case where the compressor attachment portion 100 has a groove shape, a lower end of the damper 55 disposed on the compressor attachment portion 100 may be inserted into the recess of the compressor attachment portion 100. That is, a portion of the damper 55 may be accommodated in the depth of the compressor attachment portion 100.

The compressor attachment portion 100 is not limited to the structure described above. For example, the upper surface 110a of the support portion 110 may be positioned at the same height as the upper surface 71 of the chassis 70. In this case, the compressor attachment portion 100 may be provided on a same plane as the upper surface 71 of the chassis 70 (e.g., coplanar with each other).

Referring to FIG. 5, the fastening portion 115 may protrude from the support portion 110 to a predetermined height. The fastening portion 115 may have a fastening hole 116 defined therein into which the bolt 80 (see FIG. 3) is detachably coupled. A screw thread 117 may be formed on an inner circumferential surface of the fastening hole 116.

Along a depth direction of the compressor attachment portion 100 (or a thickness direction of the chassis 70), the fastening portion 115 may have a height H for securing a length of the screw thread 117 sufficient to stably fasten the bolt 80 into the fastening hole 116. Here, the height H of the fastening portion 115 may correspond to a length from the upper surface 110a of the support portion 110 to an upper end 115a (e.g., distal end) of the fastening portion 115.

In an embodiment, an upper surface of the support portion 110 may face the compressor 51, and the fastening portion 115 may protrude from the upper surface. For example, the height H of the fastening portion 115 may be about 4.0 millimeters (mm) to about 4.5 mm in consideration of the fastening torque (e.g., about 40 kilogram-force (kgf) or more) between the fastening portion 115 and the bolt 80. If the height H of the fastening portion 115 is less than about 4.0 mm, it is difficult to secure a stable fastening torque between the fastening portion 115 and the bolt 80 because the length of the screw thread 117 which can be processed on the inner circumferential surface of the fastening hole 116 is short. If the height H of the fastening portion 115 exceeds about 4.5 mm, assemblability may deteriorate as the lower end of the damper 55 interferes with the upper end portion of the fastening portion 115.

The sheet forging and thickening technique is applied to form the compressor attachment portion 100 in the chassis 70. In this case, the fastening portion 115 is formed to have a thickness T2 larger than a thickness of the chassis 70, through a thickening process to secure a fastening torque between the fastening portion 115 and the bolt 80. For example, in a case where a thickness T1 of the support portion 110 is about 0.8 mm, the thickness T2 of the fastening portion 115 may be about 1.15 mm to about 1.2 mm. In addition, in a case where the thickness T1 of the support portion 110 is about 1.0 mm, the thickness T2 of the fastening portion 115 may be about 1.2 mm to about 1.25 mm. If the thickness T2 is less than about 1.0 mm, it may be difficult for the fastening portion 115 to secure the strength for supporting the bolt 80.

The thickness T1 of the support portion 110 is equal to the thickness of other portions of the chassis 70, such as the plate portion. For example, in a case where the thickness of the chassis 70 is about 0.8 mm, the thickness T1 of the support portion 110 may also be about 0.8 mm, and in a case where the thickness of the chassis 70 is about 1.0 mm, the thickness T1 of the support portion 110 may also be about 1.0 mm. The thickness T1 may represent a thickness of remaining portions of the chassis 70 excluding the fastening portion 115, without being limited thereto. The thicknesses described herein may be taken in a direction normal to a major surface of the respective portion, such as in a direction perpendicular thereto. In an embodiment, the fastening portion 115, the support portion 110 and the portion of the chassis 70 which is adjacent to the support portion 115 define a single body. A thickness of the support portion 110 may be the same as a thickness of the portion of the chassis which is adjacent to the support portion 1.

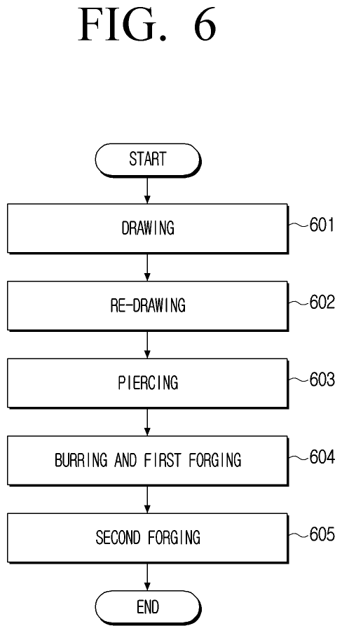

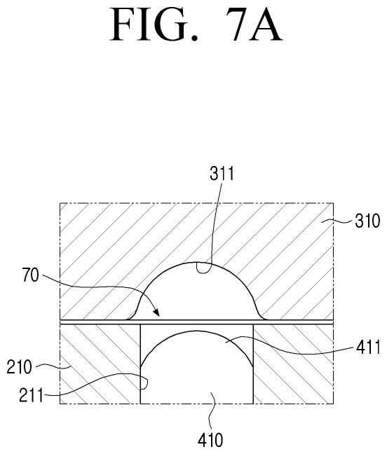

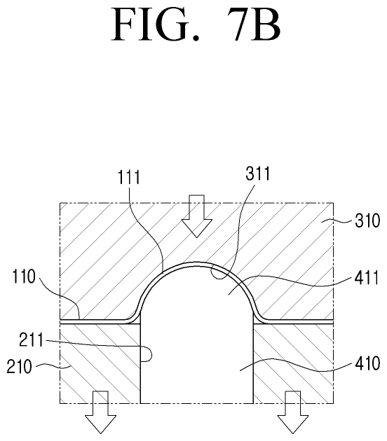

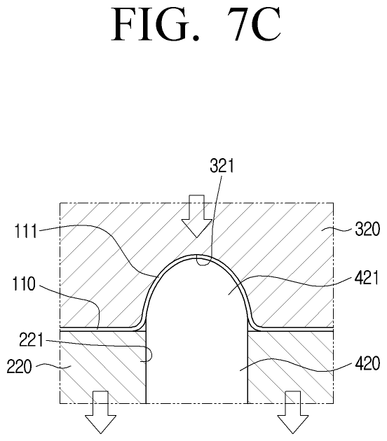

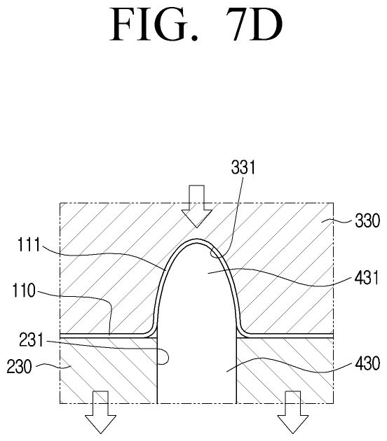

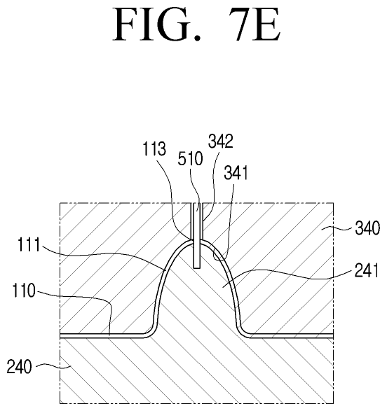

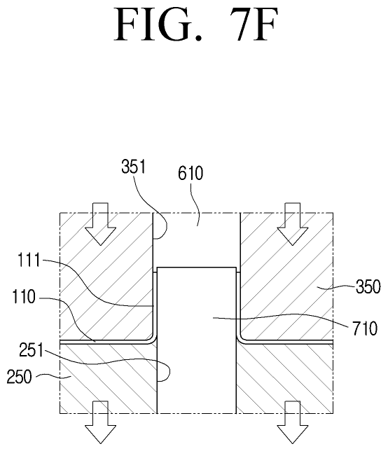

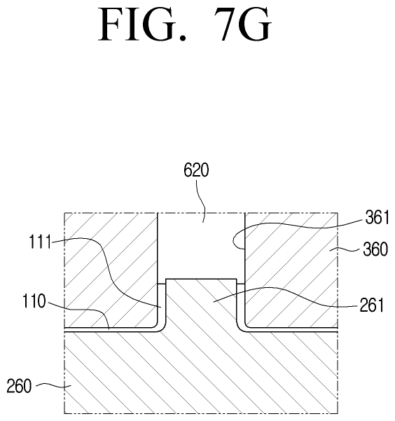

FIG. 6 is a flow chart illustrating method of providing the compressor attachment portion 100 according to an embodiment of the disclosure. FIGS. 7A to 7G are cross-sectional diagrams illustrating the method of providing the compressor attachment portion 100 according to an embodiment of the disclosure.

Hereinafter, an example in which the compressor attachment portion 100 is formed in the chassis 70 by a sheet forging and thickening process according to an embodiment of the disclosure will be described with reference to the drawings. The chassis 70 used in the disclosure may have a thickness of about 0.8 mm to about 1.0 mm. In the following description, an example in which the chassis 70 has a thickness of about 0.8 mm will be used.

Referring to FIG. 7A, a portion of the chassis 70 may be processed by the following process to integrally form the compressor attachment portion 100 with the chassis 70. That is, the compressor attachment portion 100 and a remainder of the chassis 70 may together form a single body.

FIG. 7A shows an area of the plate portion of the chassis 70 which corresponds to a location of the compressor attachment portion 100. The area of the chassis 70 is disposed on a first lower die 210. A first drawing punch 410 may be disposed in a guide hole 211 (e.g., a first guide hole) of the first lower die 210. The guide hole 211 and a surrounding portion of the lower die 210 may together correspond to a dimension, shape, etc. of the compressor attachment portion 100 to be formed at the area of the chassis 70. The first lower die 210 may be elastically supported at a lower portion, by an elastic member (not shown) so that the first lower die 210 is movable up and down. The elastic member may bias the first lower die 210 in the upward direction. The up-and-down direction may be the vertical direction of FIG. 7A, that is, along a thickness direction of the chassis 70.

The first lower die 210 may move down by being pressed by a first upper die 310 moving down. That is, the first lower die 210 and the first upper die 310 may move together with each other. When the first upper die 310 moves up and the pressing force applied to the first lower die 210 is released, the first lower die 210 can move up and return to its original position due to the elastic force of the elastic member. The first drawing punch 410 may be fixed not to move up and down. That is, the first lower die 210, the first upper die 310 and the area of the chassis 70 may each move relative to the first drawing punch 410 since the first drawing punch 410 is fixed in position along the up-and-down direction. Therefore, when the first lower die 210 moves down, a leading end portion 411 (e.g., distal end) of the first drawing punch 410 may relatively protrude toward the upper surface of the first lower die 210 by a predetermined length. While the distal end of the first drawing punch 410 is within the guide hole 211, the first lower die 210 may move along an outer surface of the first drawing punch 410 to protrude the distal end outside of the guide hole 211.

A molding groove 311 (e.g., a first molding groove) corresponding to the guide hole 211 of the first lower die 210 may be provided in the first upper die 310. A cross-sectional shape or three-dimensional shape of the molding groove 311 of the first upper die 310 may correspond to the cross-sectional shape or three-dimensional shape of the leading end portion 411 of the first drawing punch 410. For example, the leading end portion 411 of the first drawing punch 410 may be formed in a dome shape.

The first upper die 310 may face the first lower die 210 with an area of the chassis 70 therebetween. The molding method for providing the compressor attachment portion according to an embodiment of the disclosure may include a drawing process in which the first drawing punch 410 deforms a portion of the chassis 70 covering the guide hole 211 of the first lower die 210 (601 in FIG. 6).

Referring to FIG. 7B, the first upper die 310 may move down to press the first lower die 210 downward, and the two dies may move in a same direction together with each other. In this case, the leading end portion 411 of the first drawing punch 410 may protrude from the guide hole 211 of the first lower die 210. Here, a tip portion of the first drawing punch 410 may extend further than a top surface of the first lower die 210 to contact the chassis 70 which extends across the guide hole 211.

A portion of the chassis 70 fixed between the first upper die 310 and the first lower die 210 may be deformed into a shape corresponding to the molding groove 311 of the first upper die 310 by being pressed toward the molding groove 311 of the first upper die 310 by the leading end portion 411 of the first drawing punch 410. For example, a portion of the chassis 70 pressed by the leading end portion 411 of the first drawing punch 410 may be deformed from a flat shape to a curved shape.

The portion of the chassis 70 which is deformed to the curved shape (hereinafter referred to as a molded portion 111) of the chassis 70 is a portion subjected to a drawing process (e.g., an initial drawing process) to form the fastening portion 115 of the compressor attachment portion 100. Another portion of the chassis 70 which extends from and is adjacent to the molded portion 111 corresponds to the support portion 110 of the compressor attachment portion 100. The molded portion 111 of FIG. 7B may represent a preliminary fastening portion.

The molding method for providing the compressor attachment portion 100 according to an embodiment of the disclosure may include first and second re-drawing processes for gradually increasing the height of the molded portion 111 of FIG. 7B and gradually decreasing the diameter of the molded portion 111 of FIG. 7B (602 in FIG. 6). These re-drawing processes are preprocessing steps for increasing the thickness T2 of the fastening portion 115.

Referring to FIG. 7C, a second upper die 320 may move down to press a second lower die 220 downward. In this case, a leading end portion 421 of a second drawing punch 420 may protrude outwardly from a guide hole 221 (e.g., a second guide hole) of the second lower die 220.

The molded portion 111 of the chassis 70 as a preliminary fastening portion which is fixed between the second upper die 320 and the second lower die 220 is subjected to a first re-drawing process in which the molded portion 111 of the chassis 70 is pressed toward a molding groove 321 (e.g., a second molding groove) of the second upper die 320 by the leading end portion 421 of the second drawing punch 420.

The second drawing punch 420 may have a smaller diameter than the first drawing punch 410. The molding groove 321 of the second upper die 320 may have a shape (e.g., cross-sectional or three-dimension) corresponding to the leading end portion 421 of the second drawing punch 420. The molding groove 321 of the second upper die 320 may be formed to have a smaller diameter and a larger depth than the molding groove 311 of the first upper die 310. Accordingly, the molded portion 111 can be deformed to have a greater depth and extend higher than the molded portion 111 illustrated in FIG. 7B, and the molded portion 111 can be deformed to be thinner than the molded portion 111 illustrated in FIG. 7B. The molded portion 111 which has the larger height and the smaller thickness may represent a first-drawn molded portion.

Referring to FIG. 7D, when a third upper die 330 moves down and presses a third lower die 230 downward, a leading end portion 431 of a third drawing punch 430 may protrude from a guide hole 231 (e.g., a third guide hole 231) of the third lower die 230.

The molded portion 111 of the chassis 70 which is first-drawn and fixed between the third upper die 330 and the third lower die 230 is subjected to a second re-drawing process in which the molded portion 111 of the chassis 70 is pressed toward a molding groove 331 (e.g., a third molding groove) of the third upper die 330 by the leading end portion 431 of the third drawing punch 430.

The third drawing punch 430 may have a smaller diameter than the second drawing punch 420. The molding groove 331 of the third upper die 330 may have a shape corresponding to the leading end portion 431 of the third drawing punch 430. The molding groove 331 of the third upper die 330 may be formed to have a smaller diameter and a larger depth than the molding groove 321 of the second upper die 320. Accordingly, the molded portion 111 which is first-drawn can be deformed to be higher than the molded portion 111 illustrated in FIG. 7C, and the molded portion 111 can be deformed to be thinner than the molded portion 111 illustrated in FIG. 7C. In this case, the thickness of the molded portion 111 may be about 0.5 mm. The molded portion 111 which has the height which is twice increased and the thickness which is twice decreased may represent a second-drawn molded portion.

Referring to FIG. 7E, the molding method for providing the compressor attachment portion according to an embodiment of the disclosure may include a piercing process for forming a hole at an upper end (e.g., a distal end) of the molded portion 111 (603 in FIG. 6). The process of forming a through hole 113 of the molded portion 111 may be a preprocessing process capable of smoothly performing a burring process.

A molding groove 341 (e.g., a fourth molding groove) of a fourth upper die 340 may have the same shape and size as the molding groove 331 of the third upper die 330. The fourth upper die 340 may have a guide hole 342 as a punch guide hole defined therein, which is open at opposing surfaces of the die.

A fourth lower die 240 may have a support protrusion 241 corresponding to the molding groove 341 of the fourth upper die 340. The support protrusion 241 may be a part of the fourth lower due 240, such as a protruded portion thereof.

The support protrusion 241 of the fourth lower die 240 may be inserted into the molded portion 111 to support the molded portion 111.

A first piercing punch 510 may be extended through the guide hole 342 provided in the fourth upper die 340 to perforate the center of the upper end of the molded portion 111. The through hole 113 may be formed at the center of the upper end of the molded portion 111 by the first piercing punch 510. The through hole 113 of the molded portion 111 may have a diameter approximately corresponding to the diameter of the first piercing punch 510. The molded portion 111 which has the through hole 113 defined therein may represent a pierced molded portion.

The molding method for providing the compressor attachment portion according to an embodiment of the disclosure may include a burring process and a first forging process as preprocessing steps for molding the molded portion 111 (e.g., the pierced molded portion) into in the final form of the fastening portion 115 (604 in FIG. 6).

Referring to FIG. 7F, when a fifth upper die 350 moves down to press a fifth lower die 250 in a state where the molded portion 111 of the chassis 70 which is pierced is disposed on the fifth lower die 250, portions of the chassis 70 extended from the through hole 113 move downward together with the fifth lower die 250 and the fifth upper die 350. In this case, the portions of the chassis 70 which form the pieced molded portion may be deformed into a burring shape by a first burring punch 710 penetrating through the chassis 70 at the through hole 113, where the first burring punch 710 is fixed not to move up and down. The first burring punch 710 may be inserted into a guide hole 251 (e.g., a fifth guide hole) of the fifth lower die 250.

In an embodiment, the portions of the chassis 70 extended from the through hole 113, the fifth lower die 250 and the fifth upper die 350 move together with each other along an outer surface of the first burring punch 710 to widen the through hole 113 and separate the portions of the chassis 70 which are extended therefrom. The molded portion 111 which has the through hole 113 widened may represent a burred molded portion. The portions of the chassis 70 in the burred molded portion may be a preliminary form of the fastening portion 115.

An outer circumferential surface of the molded portion 111 deformed into the burring shape may come into contact with a guide hole 351 (e.g., s fifth guide hole) of the fifth upper die 350, and an inner circumferential surface of the molded portion 111 may come into contact with an outer surface of the first burring punch 710. In this state, a first forging punch 610 moves up and down along the guide hole 351 of the fifth upper die 350, striking the upper end of the molded portion 111 to increase the thickness of the molded portion 111. Here, a downward force of the first forging punch 610 compresses the portions of the chassis 70 in a thickness direction (e.g., vertical in FIG. 7F) to increase a thickness of the burred molded portion. The molded portion 111 which has the increased thickness (and decreased height) may represent a first-forged molded portion.

In FIGS. 7B through 7F, a thickness of the support portion 110 may remain substantially the same.

The molding method for providing the compressor attachment portion according to an embodiment of the disclosure may include a second forging process to increase the thickness of the first-forged molded portion 111 (605 in FIG. 6).

Referring to FIG. 7G, the chassis 70 is disposed on a sixth lower die 260. In this case, a support protrusion 261 formed at an upper surface of the sixth lower die 260 may be inserted into the first-forged molded portion 111.

In this state, when a sixth upper die 360 moves down, the molded portion 111 is inserted into a guide hole 361 (e.g., a sixth guide hole) of the sixth upper die 360. A second forging punch 620 moves up and down along the guide hole 361 of the sixth upper die 360, striking the upper end of the molded portion 111 to further increase the thickness of the molded portion 111. Accordingly, the thickness of the molded portion 111 can be formed to be thicker than the thickness of the support portion 110 and/or a remainder of the chassis 70. For example, by the secondary forging process, the thickness of the molded portion 111 can be increased to about 1.15 mm to about 2.0 mm, and the height of the molded portion 111 can be about 4.0 mm to about 4.5 mm. The molded portion 111 which has the further increased thickness (and further decreased height) may represent a second-forged molded portion.

After the second forging process is completed, a tapping process (not shown) may be performed on the inner circumferential surface of the molded portion 111 to form a screw thread. The second-forged molded portion having the screw thread defined therein may substantially represent the compressor attachment portion 100 having the fastening portion 115 with a larger thickness than a remainder of the chassis 70.

Although not shown, between processes shown in FIGS. 7A through 7G and between FIG. 7G and the tapping process, upper and lower dies and corresponding punches, support protrusions, etc. of a previous process may be separated from the area of the chassis 70 and upper and lower dies and corresponding punches, support protrusions, etc. of a next process may be disposed relative to the area of the chassis 70 as shown in the cross-sectional views.

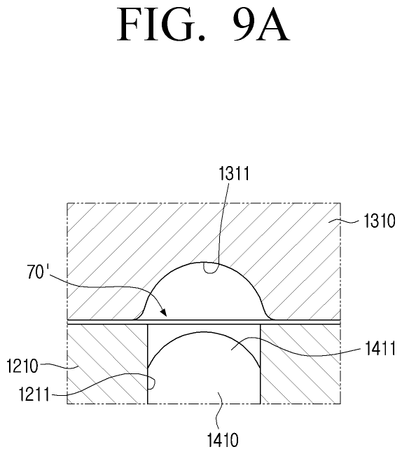

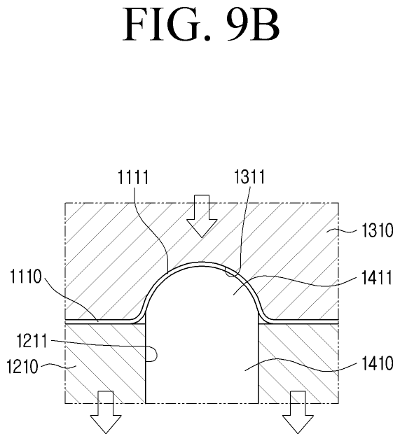

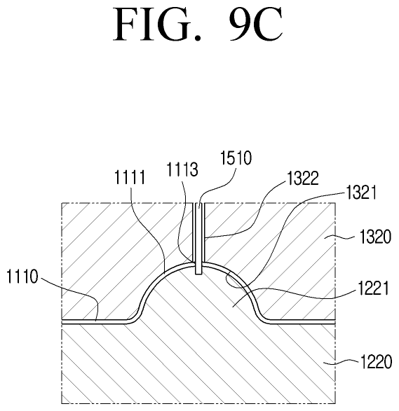

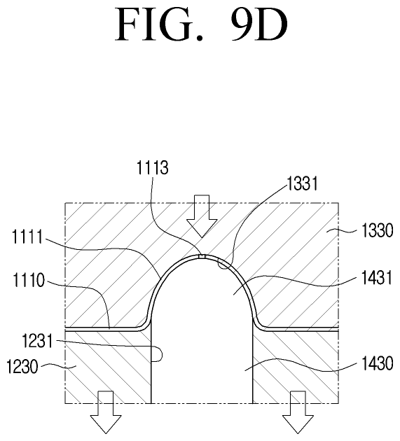

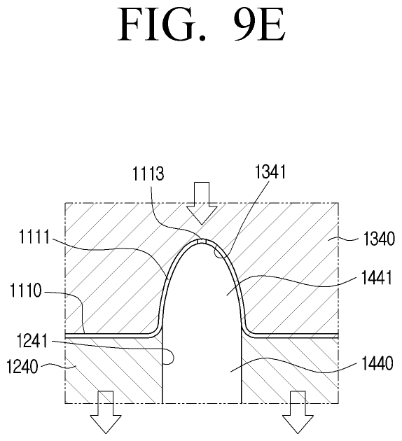

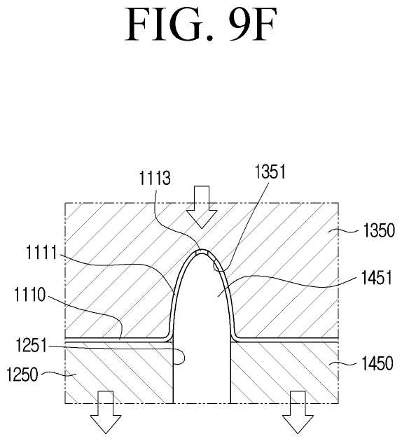

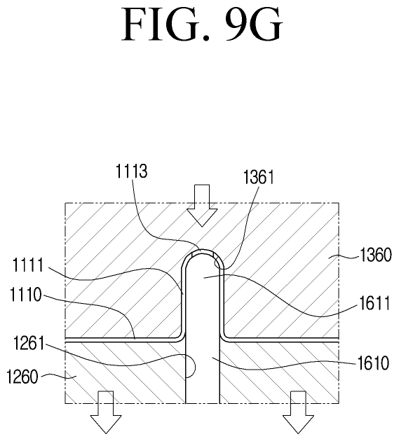

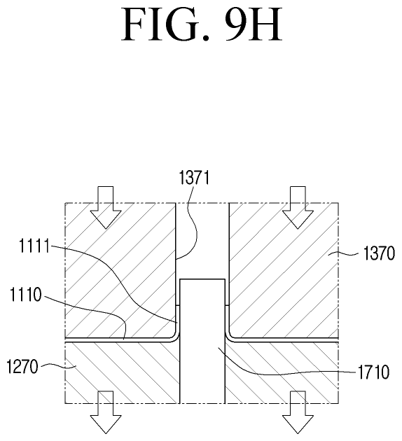

The above-described forming method can be applied when the thickness of the chassis 70 is about 0.8 mm to about 1.0 mm. In a case where a chassis 70′ (see FIG. 9A) has a thickness of more than about 1.0 mm (for example, about 1.2 mm to about 1.4 mm), the compressor attachment portion can be integrally formed with the chassis 70′ by a molding method other than the above-described molding method. In this case, when the thickness of the support portion is about 1.2 mm to about 1.4 mm, the thickness of the fastening portion can be approximately 1.1 mm to approximately 1.3 mm.

Hereinafter, a process for integrally forming a compressor attachment portion with the chassis 70′ as a single body (see FIG. 9A) when the thickness of the chassis 70′ is about 1.4 mm will be described with reference to the drawings. Descriptions above with details about processes in FIGS. 7A to 7G may be applied to similar processes described below for FIGS. 9A-9H.

In an embodiment, a method for providing a compressor chassis (e.g., chassis 70) of a cooling appliance includes providing a chassis as a single body defining a fastening portion 115 at which a compressor 51 of a cool air generator is fastened to the chassis 70 by a fastening member screw-coupled to the chassis 70, and a support portion 110 which is extended from the fastening portion 115, has a thickness and connects the fastening portion 115 to a portion of the chassis which is adjacent to the support portion. The method includes in a drawing process (FIGS. 7A and 7B), deforming a portion of the chassis 70 which corresponds to the fastening portion 115 using a first drawing punch 410 having a diameter, to provide a molded portion 111 of the chassis 70 which is convex and has a height, a thickness and a diameter. The method includes in a re-drawing process (FIGS. 7C and 7D), increasing the height, decreasing the thickness and decreasing the diameter of the molded portion 111 using a second drawing punch having a diameter which is smaller than the diameter of the first drawing punch, to provide a re-drawn molded portion of the chassis having a height, a thickness and a diameter. The method incudes in a piercing process (FIG. 7E), perforating an upper end of the re-drawn molded portion using a piercing punch to provide a through hole penetrating the upper end of the re-drawn molded portion. The method includes in a first forging process (FIG. 7F), widening the through hole of the re-drawn molded portion by penetrating the through hole using a burring punch, and increasing the thickness of the re-drawn molded portion using a first forging punch striking an upper end of the re-drawn molded portion, to provide the fastening portion having a first thickness. The method includes in a second forging process (FIG. 7F), striking an upper end of the fastening portion which has the first thickness using a second forging punch to provide the fastening member having a second thickness which is larger than the first thickness and larger than the thickness of the support portion.

The re-drawing process may include a first re-drawing process (FIG. 7C) which deforms the molded portion to provide the molded portion having a first height and a first diameter, and a second re-drawing process (FIG. 7D) which deforms the molded portion which has the first height and the first diameter to provide the molded portion having a second height larger than the first height and a second diameter smaller than the first diameter.

The method may further include providing a screw thread on an inner circumferential surface of the fastening portion having the second thickness at which the fastening member is screw-coupled to the chassis.

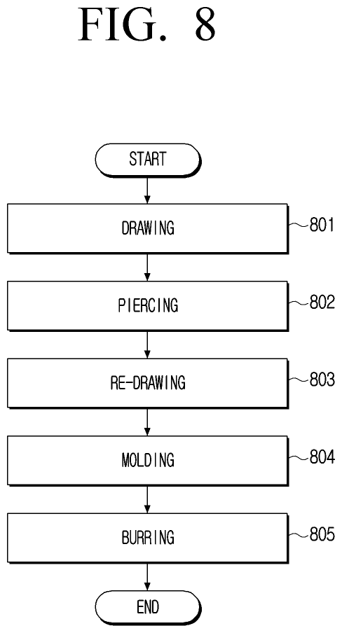

FIG. 8 is a flow chart illustrating a method of providing the compressor attachment portion 100 according to an embodiment of the disclosure. FIGS. 9A to 9H are cross-sectional diagrams illustrating the method of providing the compressor attachment portion according to an embodiment of the disclosure.

Referring to FIG. 9A, the chassis 70′ is disposed on a seventh lower die 1210. A third drawing punch 1410 may be disposed in a guide hole 1211 of the seventh lower die 1210. A lower portion of the seventh lower die 1210 may be elastically supported by an elastic member so that the seventh lower die 1210 is movable up and down.

The seventh lower die 1210 may move down by being pressed by a seventh upper die 1310 moving down. When the seventh upper die 1310 moves up and the pressing force applied to the seventh lower die 1210 is released, the seventh lower die 1210 can move up and return to its original position due to the elastic force (e.g., a biasing force) of the elastic member. A fourth drawing punch 1410 may be fixed not to move up and down, but dies may be moveable relative thereto. Therefore, when the seventh lower die 1210 moves down, a leading end portion 1411 of the fourth drawing punch 1410 may relatively protrude toward the upper surface of the seventh lower die 1210 by a predetermined length.

A molding groove 1311 corresponding to the guide hole 1211 of the seventh lower die 1210 may be provided in the seventh upper die 1310. The molding groove 1311 of the seventh upper die 1310 may correspond to the shape of the leading end portion 1411 of the fourth drawing punch 1410. For example, the leading end portion 1411 of the fourth drawing punch 1410 may be formed in a dome shape.

The molding method for providing the compressor attachment portion 100 according to an embodiment of the disclosure may include a drawing process in which the fourth drawing punch 1410 deforms a portion of the chassis 70′ covering the guide hole 1211 of the seventh lower die 1210 (801 in FIG. 8).

Referring to FIG. 9B, the seventh upper die 1310 may move down to press the seventh lower die 1210 downward. In this case, the leading end portion 1411 of the fourth drawing punch 1410 may protrude from the guide hole 1211 of the seventh lower die 1210.

A portion of the chassis 70′ fixed between the seventh upper die 1310 and the seventh lower die 1210 may be deformed into a shape corresponding to the molding groove 1311 of the seventh upper die 1310 by being pressed toward the molding groove 1311 of the seventh upper die 1310 by the leading end portion 1411 of the fourth drawing punch 1410. For example, a portion of the chassis 70′ pressed by the leading end portion 1411 of the fourth drawing punch 1410 may be deformed from a flat shape to a curved shape.

A molded portion 1111 deformed to the curved shape of the chassis 70′ is a portion subjected to a drawing process to form a fastening portion 115 of the compressor attachment portion 10. Another portion of the chassis 70′ adjacent to the molded portion 1111 corresponds to a support portion 1110 of the compressor attachment portion.

The molding method for providing the compressor attachment portion according to an embodiment of the disclosure may include a piercing process for forming a hole at an upper end of the molded portion 1111 (802 in FIG. 8).

Referring to FIG. 9C, a molding groove 1321 of an eighth upper die 1320 may have the same shape and size as the molding groove 1311 of the seventh upper die 1310. An eighth lower die 1220 may have a support protrusion 1221 corresponding to the molding groove 1321 of the eighth upper die 1320.

The support protrusion 1221 of the eighth lower die 1220 may be inserted into the molded portion 1111 to support the molded portion 1111.

A second piercing punch 1510 may be brought into a guide hole 1322 provided in the eighth upper die 1320 to perforate the center of the upper end of the molded portion 1111. A through hole 1113 may be formed at the center of the upper end of the molded portion 1111 by the second piercing punch 1510. The through hole 1113 of the molded portion 1111 may have a diameter approximately corresponding to the diameter of the second piercing punch 1510.

The molding method for providing the compressor attachment portion 100 according to an embodiment of the disclosure may include first, second, and third re-drawing processes for gradually increasing the height of the molded portion 1111 of FIG. 9C and gradually decreasing the diameter of the molded portion 1111 of FIG. 9C (803 in FIG. 8). The plurality of re-drawing processes are preprocessing steps for increasing the thickness of the fastening portion 115 of the compressor attachment portion 100. The re-drawing process may be performed more times in this molding method for providing the compressor attachment portion 100 than in the above-described molding method for the compressor attachment portion 100, considering that the chassis 70′ has a larger thickness than the chassis 70 described above.

Referring to FIG. 9D, a ninth upper die 1330 may move down to press a ninth lower die 1230 downward. In this case, a leading end portion 1431 of a fifth drawing punch 1430 may protrude from a guide hole 1231 of the ninth lower die 1230.

The molded portion 1111 of the chassis 70′ fixed between the ninth lower die 1230 and the ninth upper die 1330 is subjected to a first re-drawing process in which the molded portion 1111 of the chassis 70′ is pressed toward a molding groove 1331 of the ninth upper die 1330 by the leading end portion 1431 of the fifth drawing punch 1430.

The molding groove 1331 of the ninth upper die 1330 may be formed to have a smaller diameter and a larger depth than the molding groove 1321 of the eighth upper die 1320. Accordingly, the molded portion 1111 having the through hole 1113 defined therein can be deformed to be higher than the molded portion 1111 illustrated in FIG. 9B, and the molded portion 1111 can be deformed to be thinner than the molded portion 1111 illustrated in FIG. 9B. The molded portion 1111 after the process in FIG. 9D may be a first-drawn molded portion.

Referring to FIG. 9E, a tenth upper die 1340 may move down to press a tenth lower die 1240 downward. In this case, a leading end portion 1441 of a sixth drawing punch 1440 may protrude from a guide hole 1241 of the tenth lower die 1240.

The molded portion 1111 of the chassis 70′ fixed between the tenth lower die 1240 and the tenth upper die 1340 is subjected to a second re-drawing process in which the molded portion 1111 of the chassis 70′ which is first-drawn is pressed toward a molding groove 1341 of the tenth upper die 1340 by the leading end portion 1441 of the sixth drawing punch 1440.

The molding groove 1341 of the tenth upper die 1340 may be formed to have a smaller diameter and a larger depth than the molding groove 1331 of the ninth upper die 1330. Accordingly, the molded portion 1111 can be deformed to be higher than the molded portion 1111 illustrated in FIG. 9D, and the molded portion 1111 can be deformed to be thinner than the molded portion 1111 illustrated in FIG. 9D. In addition, the through hole 1113 formed at the center of the upper end of the molded portion 1111 may have a larger size than that in the molded portion 1111 illustrated in FIG. 9D. The molded portion 1111 after the process in FIG. 9E may be a second-drawn molded portion.

Referring to FIG. 9F, an eleventh upper die 1350 may move down to press an eleventh lower die 1250 downward. In this case, a leading end portion 1451 of a seventh drawing punch 1450 may protrude from a guide hole 1251 of the eleventh lower die 1250.

The molded portion 1111 of the chassis 70′ fixed between the eleventh lower die 1250 and the eleventh upper die 1350 is subjected to a third re-drawing process in which the molded portion 1111 of the chassis 70′ is pressed toward a molding groove 1351 of the eleventh upper die 1350 by a leading end portion 1451 of a seventh drawing punch 1450.

The molding groove 1351 of the eleventh upper die 1350 may be formed to have a smaller diameter and a larger depth than the molding groove 1341 of the tenth upper die 1340. Accordingly, the molded portion 1111 can be deformed to be higher than the molded portion 1111 illustrated in FIG. 9E, and the molded portion 1111 can be deformed to be thinner than the molded portion 1111 illustrated in FIG. 9E. In addition, the through hole 1113 formed at the center of the upper end of the molded portion 1111 may have a larger size than that in the molded portion 1111 illustrated in FIG. 9E. The molded portion 1111 after the process in FIG. 9F may be a third-drawn molded portion.

The molding method for providing the compressor attachment portion 100 according to an embodiment of the disclosure may include a molding process for gradually increasing the height of the molded portion 1111 of FIG. 9F and gradually decreasing the diameter of the molded portion 1111 of FIG. 9F (804 in FIG. 8).

Referring to FIG. 9G, a twelfth upper die 1360 may move down to press a twelfth lower die 1260 downward. In this case, a leading end portion 1611 of a molding punch 1610 may protrude from a guide hole 1261 of the twelfth lower die 1260.

The molded portion 1111 of the chassis 70′ fixed between the twelfth lower die 1260 and the twelfth upper die 1360 is subjected to a molding process in which the molded portion 1111 of the chassis 70′ is pressed toward a molding groove 1361 of the twelfth upper die 1360 by the leading end portion 1611 of the molding punch 1610.

Through the molding process, the molded portion 1111 can be deformed to have a smaller diameter than the molded portion 1111 illustrated in FIG. 9F. However, the height of the molded portion 1111 can be kept substantially equal to the height of the molded portion 1111 illustrated in FIG. 9F.

The molding method for providing the compressor attachment portion 100 according to an embodiment of the disclosure may include a burring process for molding the molded portion 1111 in the preliminary form shape of the fastening portion 115 of the compressor attachment portion 100 (805 in FIG. 8).

Referring to FIG. 9H, when a thirteenth upper die 1370 moves down to press a thirteenth lower die 1270 in a state where the molded portion 1111 of the chassis 70′ is disposed on the thirteenth lower die 1270, the chassis 70′ moves downward together with the thirteenth lower die 1270.

In this case, an upper portion of the molded portion 1111 may be penetrated by a second burring punch 1710 fixed not to move up and down. After penetrating the upper portion of the molded portion 1111, the second burring punch 1710 is brought into a guide hole 1371 of the thirteenth upper die 1370. Through the burring process, the molded portion 1111 can be deformed into a burring shape and molded in the form of the fastening portion 115 of the compressor attachment portion 100.

After the burring process is completed, a screw thread may be formed on the inner circumferential surface of the molded portion 1111 through a tapping process on the molded portion 1111.

In an embodiment, a method for providing a compressor chassis of a cooling appliance, the method includes in a drawing process (FIGS. 9A and 9B), deforming a portion of the chassis which corresponds to the fastening portion using a first drawing punch having a diameter, to provide a molded portion of the chassis which is convex and has a height, a thickness and a diameter. The method includes in a piercing process (FIG. 9C), perforating an upper end of the molded portion using a piercing punch to provide a through hole penetrating the upper end of the molded portion. The method includes in a re-drawing process (FIGS. 9D, 9E and 9F), increasing the height, decreasing the thickness and decreasing the diameter of the molded portion having the through hole using a second drawing punch having a diameter which is smaller than the diameter of the first drawing punch, to provide a re-drawn molded portion of the chassis having a height, a thickness and a diameter. The method includes in a molding process (e.g., FIG. 9G), decreasing the diameter of the re-drawn molded portion using a molding punch having a smaller diameter than the diameter of the second drawing punch. The method includes in a forging process (FIG. 9H, also referred to as a burring process), widening the through hole of the re-drawn molded portion by penetrating the through hole using a burring punch to provide the fastening portion having a thickness smaller than the thickness of the support portion.

The re-drawing process may be repeated including a plurality of re-drawing processes each of which respectively increases a previous thickness together with decreasing a previous diameter of the molded portion (FIGS. 9D, 9E and 9F, in order, for example).

The fastening portion 115 of the compressor attachment portion 100 formed according to the above-described molding method for the compressor attachment portion 100 may have a thickness of about 1.3 mm, which is smaller than the thickness of the support portion 1110 of the compressor attachment portion 100, which is about 1.4 mm. However, even though the thickness of walls of the fastening portion 115 are smaller than the thickness of the support portion 1110 and/or remaining portions of the chassis 70′ at the compressor attachment portion 100, since the thickness of the fastening portion 115 of the compressor attachment portion 100 is about 1.0 mm or more, it is possible to satisfy the fastening torque required between the fastening portion 115 and the bolt 80. That is, one or more embodiment of a method of providing a fastening portion 115 may form a thickness of the fastening portion 115 as a minimum of about 1.0 mm or more.

In addition, in a case where the chassis 70′ has a thickness of about 1.2 mm, the compressor attachment portion 100 can be integrally formed with the chassis 70′ as a single body through the above-described molding method. In this case, the fastening portion 115 of the compressor attachment portion 100 may have a thickness of about 1.1 mm, which is smaller than the thickness of the support portion 1110 of the compressor attachment portion 100, which is about 1.2 mm. However, since the thickness of the fastening portion 115 of the compressor attachment portion 100 is about 1.0 mm or more, it is possible to satisfy the fastening torque required between the fastening portion 115 and the bolt 80.

The compressor attachment portion 100 according to one or more embodiment of the disclosure does not require a separate bracket to connect the chassis 70 and the compressor 51 to each other. In addition, since the compressor attachment portion 100 according to an embodiment of the disclosure is formed integrally with the chassis 70 to provide a single body by processing a partial area of the chassis 70, a process of spot-welding a separate bracket to the chassis 70 can be omitted, thereby reducing the number of parts and assembly work, as a result improving productivity and reducing manufacturing costs.

In an embodiment, a cooling appliance include a main body in which a compressor chamber is defined, a chassis which is in the compressor chamber, the chassis being integrally formed and defining a fastening portion to which a fastening member is screw-coupled to the chassis, and a support portion which is extended from the fastening portion and connects the fastening portion to a portion of the chassis which is adjacent to the support portion (like at upper surface 71 of the chassis 70, and a compressor of a cool air generator which is in the compressor chamber, penetrated by the fastening member and detachably attached to the chassis by the fastening member.

In the cooling appliance, the fastening portion and the support portion together may define a single body, a through hole may be defined in the chassis at the fastening portion, the fastening member being screw-coupled to the chassis via the through hole, and the fastening portion may include a drawn-and-pierced portion of the single body. Here, the drawn-and-pierced portion of the single body may define the through hole and a thickness of the chassis at the fastening portion which is larger (or smaller) than a thickness of the chassis at the support portion, according to embodiments of the methods disclosed herein.

In the cooling appliance, an upper surface of the support portion may be recessed from the portion of the chassis which is adjacent to the support portion (FIG. 4, for example), and the fastening portion may protrude from the upper surface of the support portion and includes the drawn-and-pierced portion of the single body.

Although embodiments of the disclosure have been illustrated and described above, the disclosure is not limited to the specific embodiments described above, and various modification may be made by those skilled in the art without departing from the gist of the disclosure as claimed in the claims. Such modifications should not be individually understood from the technical spirit or prospect of the disclosure.

What is claimed is:

1. A cooling appliance comprising:
a main body in which a compressor chamber is defined;
a chassis which is in the compressor chamber, the chassis defining:
a fastening portion to which a fastening member is screw-coupled to the chassis, and
a support portion which is extended from the fastening portion and connects the fastening portion to a portion of the chassis which is adjacent to the support portion; and
a compressor of a cool air generator which is in the compressor chamber, penetrated by the fastening member and detachably attached to the chassis by the fastening member.

2. The cooling appliance as claimed in claim 1, wherein
the fastening portion, the support portion and the portion of the chassis which is adjacent to the support portion define a single body, and
a thickness of the support portion is the same as a thickness of the portion of the chassis which is adjacent to the support portion.

3. The cooling appliance as claimed in claim 2, wherein within the single body of the chassis, the thickness of the support portion is about 0.8 millimeter to about 1.0 millimeter.

4. The cooling appliance as claimed in claim 3, wherein within the single body of the chassis, a thickness of the fastening portion is larger than the thickness of the support portion.

5. The cooling appliance as claimed in claim 4, wherein the thickness of the fastening portion is about 1.15 millimeters to about 1.25 millimeters.

6. The cooling appliance as claimed in claim 2, wherein the thickness of the support portion is about 1.2 millimeters to about 1.4 millimeters.

7. The cooling appliance as claimed in claim 6, wherein a thickness of the fastening portion is smaller than the thickness of the support portion.

8. The cooling appliance as claimed in claim 7, wherein the thickness of the fastening portion is about 1.1 millimeters to about 1.3 millimeters.

9. The cooling appliance as claimed in claim 1, wherein
the fastening portion, the support portion and the portion of the chassis which is adjacent to the support portion define a single body,
an upper surface of the support portion faces the compressor, and
the fastening portion protrudes from the upper surface and has a height of about 4.0 millimeters to about 4.5 millimeters from the upper surface of the support portion.

10. A method for providing a compressor chassis of a cooling appliance, the method comprising:
providing a chassis as a single body defining:
a fastening portion at which a compressor of a cool air generator is fastened to the chassis by a fastening member screw-coupled to the chassis, and
a support portion which is extended from the fastening portion, has a thickness and connects the fastening portion to a portion of the chassis which is adjacent to the support portion;
in a drawing process, deforming a portion of the chassis which corresponds to the fastening portion using a first drawing punch having a diameter, to provide a molded portion of the chassis which is convex and has a height, a thickness and a diameter;
in a re-drawing process, increasing the height, decreasing the thickness and decreasing the diameter of the molded portion using a second drawing punch having a diameter which is smaller than the diameter of the first drawing punch, to provide a re-drawn molded portion of the chassis having a height, a thickness and a diameter;
in a piercing process, perforating an upper end of the re-drawn molded portion using a piercing punch to provide a through hole penetrating the upper end of the re-drawn molded portion;
in a first forging process:
widening the through hole of the re-drawn molded portion by penetrating the through hole using a burring punch, and
increasing the thickness of the re-drawn molded portion using a first forging punch striking an upper end of the re-drawn molded portion, to provide the fastening portion having a first thickness; and
in a second forging process, striking an upper end of the fastening portion which has the first thickness using a second forging punch to provide the fastening member having a second thickness which is larger than the first thickness and larger than the thickness of the support portion.

11. The method as claimed in claim 10, wherein the re-drawing process includes:
a first re-drawing process which deforms the molded portion to provide the molded portion having a first height and a first diameter; and
a second re-drawing process which deforms the molded portion which has the first height and the first diameter to provide the molded portion having a second height larger than the first height and a second diameter smaller than the first diameter.

12. The method as claimed in claim 11, further comprising providing a screw thread on an inner circumferential surface of the fastening portion having the second thickness at which the fastening member is screw-coupled to the chassis.

13. A method for providing a compressor chassis of a cooling appliance, the method comprising:
providing a chassis as a single body defining:
a fastening portion at which a compressor of a cool air generator is fastened to the chassis by a fastening member screw-coupled to the chassis, and
a support portion which is extended from the fastening portion, has a thickness and connects the fastening portion to a portion of the chassis which is adjacent to the support portion;
in a drawing process, deforming a portion of the chassis which corresponds to the fastening portion using a first drawing punch having a diameter, to provide a molded portion of the chassis which is convex and has a height, a thickness and a diameter;
in a piercing process, perforating an upper end of the molded portion using a piercing punch to provide a through hole penetrating the upper end of the molded portion;
in a re-drawing process, increasing the height, decreasing the thickness and decreasing the diameter of the molded portion having the through hole using a second drawing punch having a diameter which is smaller than the diameter of the first drawing punch, to provide a re-drawn molded portion of the chassis having a height, a thickness and a diameter;
in a molding process, decreasing the diameter of the re-drawn molded portion using a molding punch having a smaller diameter than the diameter of the second drawing punch; and
in a forging process, widening the through hole of the re-drawn molded portion by penetrating the through hole using a burring punch to provide the fastening portion having a thickness smaller than the thickness of the support portion.

14. The method as claimed in claim 13, wherein the re-drawing process is repeated including a plurality of re-drawing processes each of which respectively increases a previous thickness together with decreasing a previous diameter of the molded portion.

15. The method as claimed in claim 13, further comprising providing a screw thread on an inner circumferential surface of the fastening portion having the second thickness at which the fastening member is screw-coupled to the chassis.

16. The cooling appliance as claimed in claim 1, wherein
the fastening portion and the support portion together define a single body,
a through hole is defined in the chassis at the fastening portion, the fastening member being screw-coupled to the chassis via the through hole, and
the fastening portion includes a drawn-and-pierced portion of the single body.

17. The cooling appliance as claimed in claim 16, wherein the drawn-and-pierced portion of the single body defines the through hole and a thickness of the chassis at the fastening portion which is larger than a thickness of the chassis at the support portion.

18. The cooling appliance as claimed in claim 16, wherein the drawn-and-pierced portion of the single body defines the through hole and a thickness of the chassis at the fastening portion which is smaller than a thickness of the chassis at the support portion.

19. The cooling appliance as claimed in claim 16, wherein
an upper surface of the support portion is recessed from the portion of the chassis which is adjacent to the support portion, and
the fastening portion protrudes from the upper surface of the support portion and includes the drawn-and-pierced portion of the single body.
